(19) United States
(12) Patent Application Publication
(10) Pub. No.: US 2026/0185498 A1
(43) Pub. Date: Jul. 2, 2026

(54) POSITIVE CRANKCASE VENTILATION (PCV) SYSTEM WITH A PCV VALVE

(71) Applicant: Ford Global Technologies, LLC, Dearborn, MI (US)

(72) Inventors: Andrew Moen, Brownstown, MI (US); Christopher B. Bishop, South Lyon, MI (US)

(21) Appl. No.: 19/008,320

(22) Filed: Jan. 2, 2025

(51) Int. Cl. F02M 25/06

(52) U.S. Cl. CPC F02M 25/06

(57) ABSTRACT

Methods and systems are provided for a positive crankcase ventilation (PCV) valve. The PCV valve includes, in one example, a housing, an orifice plate positioned within the housing, and a plunger biased by a spring and configured to travel axially through the orifice. In the PCV valve, multiple longitudinal ribs extend from an outer surface of the plunger along the whole length of the plunger or along an inner surface of the housing and are configured to delimit a reduced diameter portion of the plunger.

### FIELD

The present description relates generally to a positive crankcase ventilation (PCV) system with a PCV valve that includes ribs that are designed to reduced noise, vibration, and harshness (NVH) during valve operation.

### BACKGROUND/SUMMARY

Internal combustion engine vehicles include exhaust systems that receive gases from the engine and ultimately expel the gasses into the surrounding environment. Certain engines have included positive crankcase ventilation (PCV) systems to vent gases from the crankcase into an engine intake manifold to provide evacuation of gases from inside the crankcase in order to reduce degradation of various engine components in the crankcase. PCV valves are used to manage the airflow that is introduced into the intake system from the crankcase.

The inventors have recognized that it may be desirable to reduce noise, vibration, and harshness (NVH) which occurs during certain operating conditions in PCV valves with plungers. To elaborate, vacuum pulses through the valve can cause resonance, thereby generating NVH under certain conditions.

To achieve the NVH reductions as well as at least partially overcome other challenges the inventors developed a PCV valve. The PCV valve includes, in one example, a housing, an orifice plate positioned within the housing, and a plunger biased by a spring and configured to travel axially through the orifice plate. Further, in the valve multiple longitudinal ribs extend from an outer surface of the plunger along the whole length of the plunger or along an inner surface of the housing to the orifice plate. The longitudinal ribs interact with the orifice plate or the plunger to reduce off-axis plunger movement and specifically reduce the chance of plunger resonance. In this way, NVH during valve operation is reduced.

In one example, the multiple longitudinal ribs may be equivalently spaced about a central axis. Specifically, in such an example, the multiple longitudinal ribs may include a pair of ribs that are arranged 180º apart about the central axis. In this way, the likelihood of the plunger resonating with the orifice plate is further reduced.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic of an engine system for a vehicle system.

FIG. 2 shows an example of a positive crankcase ventilation (PCV) system.

FIGS. 3-4 show an example of a PCV valve for a PCV system.

FIG. 5 shows another example of a PCV valve.

FIGS. 6-9 show different views of the PCV valve, depicted in FIGS. 3-4.

### DETAILED DESCRIPTION

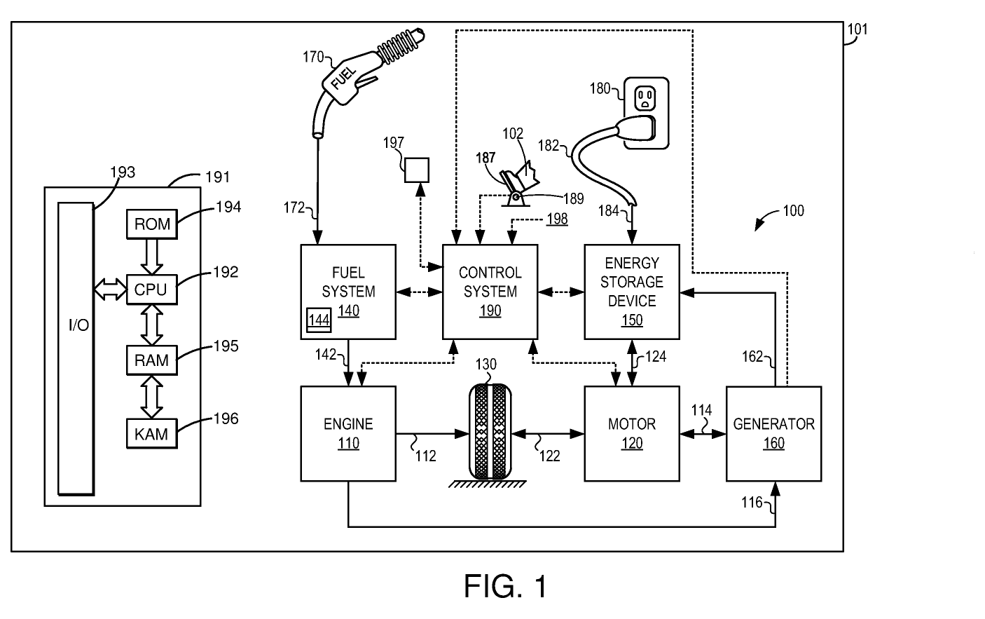

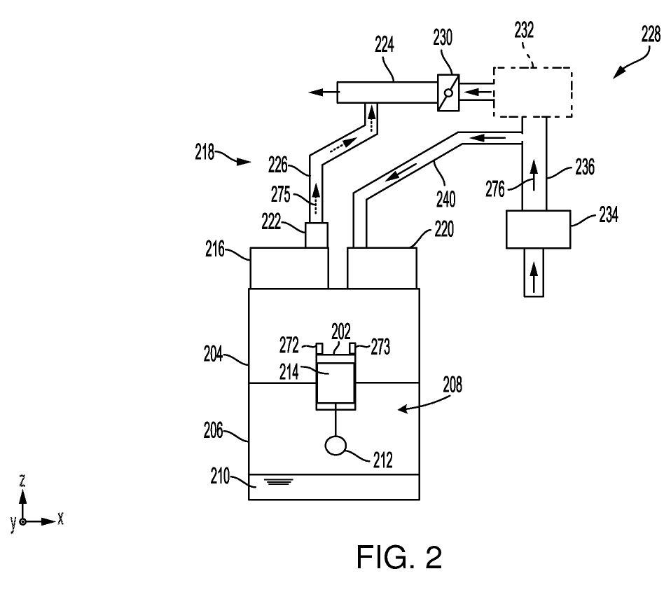

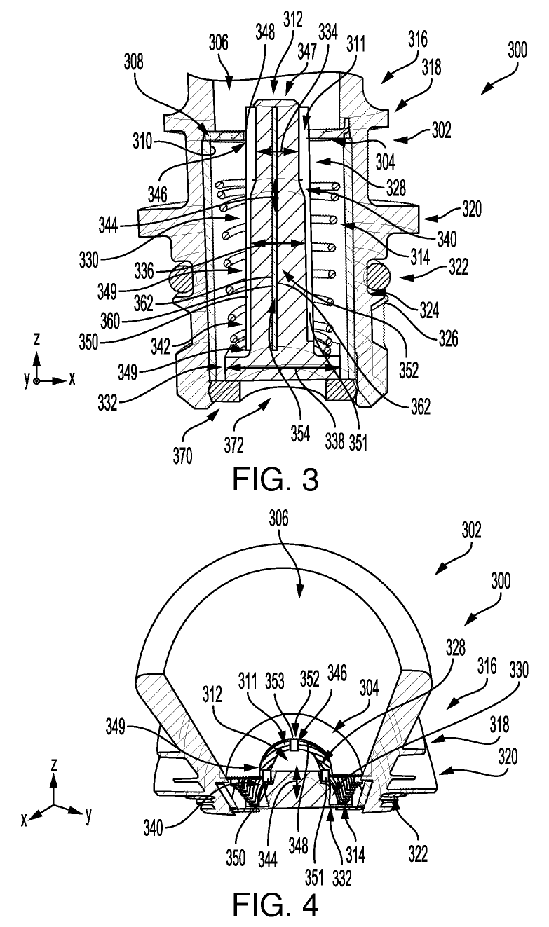

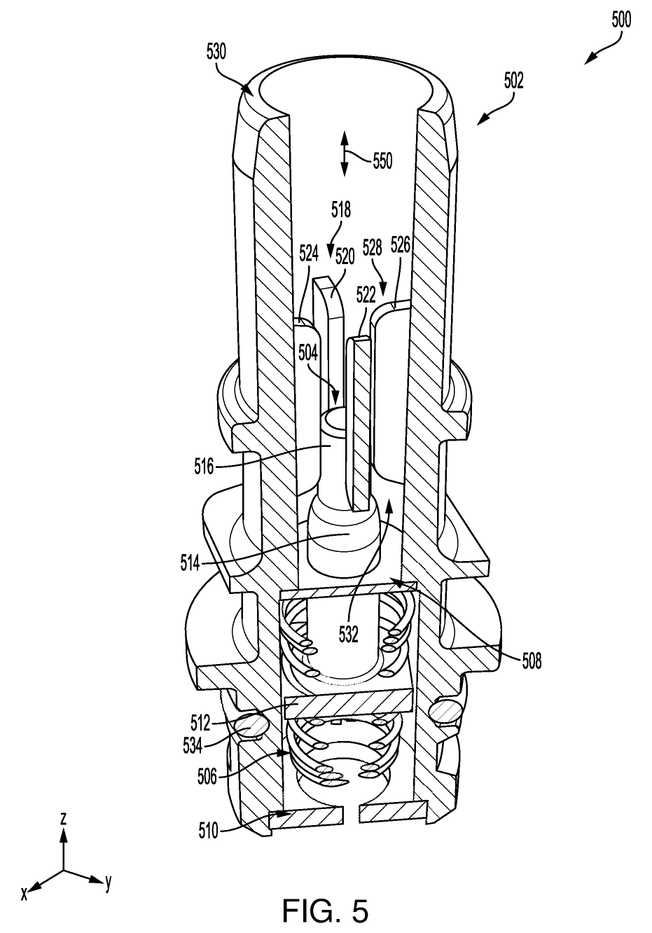

The following description relates to positive crankcase ventilation (PCV) systems with PCV valves that exhibit reduced noise, vibration, and harshness (NVH). FIG. 1 shows an example of a vehicle and FIG. 2 shows an example of a PCV system that includes a PCV valve which delivers blow-by gas from a crankcase to an intake system. FIGS. 3-4 and 6-9 show an example of a PCV valve that includes a plunger with ribs (e.g., flutes) that reduce cyclical movement of the plunger during valve operation and specifically reduce the chance of plunger resonance, thereby reducing NVH during valve operation. FIG. 5 shows another example of a PCV valve with a housing that includes ribs that extend along an inner surface to an orifice plate.

FIG. 1 illustrates an example vehicle propulsion system 100 in a vehicle 101. The vehicle propulsion system 100 includes a fuel burning engine 110 and a motor 120. As a non-limiting example, the engine 110 is an internal combustion engine (ICE) and the motor 120 comprises an electric motor. Motor 120 may be configured to utilize or consume a different energy source than engine 110. For example, engine 110 may consume a liquid fuel (e.g., gasoline) to produce an engine output while motor 120 may consume electrical energy to produce a motor output. As such, the vehicle 101 with the propulsion system 100 may be a hybrid electric vehicle (HEV). In such an example, as described in greater detail herein, the vehicle 101 includes an electric motor, a traction battery, and the like. In the hybrid vehicle example, the traction motor and the engine may have a variety of suitable architectures, as discussed in greater detail herein. However, in other examples, the vehicle may be an ICE vehicle.

Vehicle propulsion system 100 may utilize a variety of different operational modes depending on operating conditions encountered by the vehicle propulsion system. Some of these modes may enable the engine 110 to be maintained in an off state (e.g., set to a deactivated state) where combustion of fuel at the engine is discontinued. For example, under select operating conditions, the motor 120 may propel the vehicle via the drive wheel 130 as indicated by arrow 122 while engine 110 is deactivated.

During other operating conditions, the engine 110 may be set to a deactivated state (as described above) while the motor 120 may be operated to charge the energy storage device 150. For example, the motor 120 may receive wheel torque from drive wheel 130 as indicated by arrow 122 where the motor may convert the kinetic energy of the vehicle to electrical energy for storage at the energy storage device 150 as indicated by arrow 124. This operation may be referred to as regenerative speed reduction of the vehicle. Thus, the motor 120 can provide a generator function in some embodiments. However, in other embodiments, a generator 160 may instead receive wheel torque from the drive wheel 130, where the generator may convert the kinetic energy of the vehicle to electrical energy for storage at the energy storage device 150 as indicated by arrow 162.

During still other operating conditions, the engine 110 may be operated by combusting fuel received from a fuel system 140 as indicated by arrow 142. For example, the engine 110 may be operated to propel the vehicle via drive wheel 130 as indicated by arrow 112 while the motor 120 is deactivated. During other operating conditions, both the engine 110 and the motor 120 may each be operated to propel the vehicle via drive wheel 130 as indicated by arrows 112 and 122, respectively. A configuration where both the engine and the motor may selectively propel the vehicle may be referred to as a parallel type vehicle propulsion system. Note that in some embodiments, the motor 120 may propel the vehicle via a first set of drive wheels and the engine 110 may propel the vehicle via a second set of drive wheels.

In other embodiments, vehicle propulsion system 100 may be configured as a series type vehicle propulsion system, whereby the engine does not directly propel the drive wheels. Rather, the engine 110 may be operated to power the motor 120, which may in turn propel the vehicle via drive wheel 130 as indicated by arrow 122. For example, during select operating conditions, the engine 110 may drive the generator 160 as indicated by arrow 116, which may in turn supply electrical energy to one or more of the motor 120 as indicated by arrow 114 or energy storage device 150 as indicated by arrow 162. As another example, the engine 110 may be operated to drive the motor 120 which may in turn provide a generator function to convert the engine output to electrical energy, where the electrical energy may be stored at energy storage device 150 for later use by the motor.

The fuel system 140 may include one or more fuel storage tanks 144 for storing fuel on-board the vehicle. For example, the fuel tank(s) 144 may store one or more liquid fuels, including but not limited to: gasoline, diesel, and alcohol fuels. In some examples, the fuel may be stored on-board the vehicle as a blend of two or more different fuels. For example, the fuel tank(s) 144 may be configured to store a blend of gasoline and ethanol (e.g., E10, E85, etc.) or a blend of gasoline and methanol (e.g., M10, M85, etc.), whereby these fuels or fuel blends may be delivered to the engine 110 as indicated by arrow 142. Still other suitable fuels or fuel blends may be supplied to the engine 110, where they may be combusted at the engine to produce an engine output. The engine output may be utilized to propel the vehicle as indicated by arrow 112 or to recharge the energy storage device 150 via the motor 120 and/or the generator 160. The engine 110 and the other engines described herein may be configured for compression and/or spark ignition.

In some embodiments, the energy storage device 150 may be configured to store electrical energy that may be supplied to other electrical loads residing on-board the vehicle (other than the motor), including cabin heating and air conditioning, engine starting, headlights, cabin audio and video systems, etc. As a non-limiting example, the energy storage device 150 may include one or more batteries and/or capacitors.

Control system 190 may communicate with one or more of the engine 110, the motor 120, the fuel system 140, the energy storage device 150, and the generator 160. Control system 190 may receive sensory feedback information from one or more of the engine 110, the motor 120, the fuel system 140, the energy storage device 150, and the generator 160. Further, control system 190 may send control signals to one or more of the engine 110, the motor 120, the fuel system 140, the energy storage device 150, and the generator 160 responsive to this sensory feedback. The control system 190 may receive an indication of an operator requested output of the vehicle propulsion system from a vehicle operator 102. For example, the control system 190 may receive sensory feedback from a pedal position sensor 189 which communicates with a pedal 187. The pedal 191 may refer schematically to a speed reduction pedal and/or a speed adjustment pedal.

The control system 190 includes a controller 191. The controller 191 is shown in FIG. 1 as a conventional microcomputer including: microprocessor unit 192, input/output ports 193, read-excusive memory 194 (e.g., non-transitory memory), random access memory 195, keep alive memory 196, and a conventional data bus. Controller 191 is shown receiving various signals from sensors coupled to engine 110, in addition to those signals previously discussed, including: engine coolant temperature (ECT) from temperature sensor coupled to a cooling sleeve; a position sensor coupled to an driver demand pedal for sensing force applied by human foot; a position sensor coupled to caliper control pedal for sensing force applied by foot, a measurement of engine manifold pressure (MAP) from pressure sensor coupled to intake manifold; an engine position sensor from a position sensor sensing crankshaft position; a measurement of air mass entering the engine from sensor; and a measurement of throttle position from a sensor. Barometric pressure may also be sensed for processing by controller 191. A position sensor may produce a predetermined number of equally spaced pulses each revolution of the crankshaft from which engine speed (RPM) can be determined.

The controller 191 may receive various signals from sensors coupled to the engine 110, including measurement of manifold airflow pressure (MAP) sensor; engine coolant temperature (ECT) from temperature sensor exhaust gas air/fuel ratio from exhaust gas sensor; a crankcase pressure sensor (CKCP); BP sensor, TIP sensor, etc. Furthermore, the controller may monitor and adjust the position of various actuators based on input received from the various sensors. These actuators may include, for example, the throttle, and intake and exhaust valve systems. Storage medium read-only memory 194 can be programmed with computer readable data representing instructions executable by processor 192 for performing the methods described below, as well as other variants that are anticipated but not specifically listed.

During operation, each cylinder within engine 110 typically undergoes a four stroke cycle: the cycle includes the intake stroke, compression stroke, expansion stroke, and exhaust stroke. During the intake stroke, generally, the exhaust valve closes and intake valve opens. Air is introduced into combustion chamber via intake manifold, and piston moves to the bottom of the cylinder so as to increase the volume within combustion chamber. The position at which piston is near the bottom of the cylinder and at the end of its stroke (e.g., when combustion chamber is at its largest volume) is typically referred to by those of skill in the art as bottom dead center (BDC).

During the compression stroke, the intake valve and the exhaust valve are closed. The piston moves toward the cylinder head so as to compress the air within the combustion chamber. The point at which the piston is at the end of its stroke and closest to the cylinder head (e.g. when the combustion chamber is at its smallest volume) is typically referred to by those of skill in the art as top dead center (TDC). In a process hereinafter referred to as injection, fuel is introduced into the combustion chamber. In a process hereinafter referred to as ignition, the injected fuel is ignited by known ignition means such as a spark plug and/or compression ignition, resulting in combustion.

During the expansion stroke, the expanding gases push the piston back to BDC. Crankshaft converts piston movement into a rotational torque of the rotary shaft. Finally, during the exhaust stroke, the exhaust valve opens to release the combusted air-fuel mixture to the exhaust manifold and the piston returns to TDC. Note that the above is shown merely as an example, and that intake and exhaust valve opening and/or closing timings may vary, such as to provide positive or negative valve overlap, late intake valve closing, or various other examples.

The energy storage device 150 may periodically receive electrical energy from a power source 180 residing external to the vehicle (e.g., not part of the vehicle) as indicated by arrow 184. As a non-limiting example, vehicle propulsion system 100 may be configured as a plug-in HEV, whereby electrical energy may be supplied to energy storage device 150 from the power source 180 via an electrical energy transmission cable 182. During a recharging operation of the energy storage device 150 from the power source 180, the electrical transmission cable 182 may electrically couple the energy storage device 150 and the power source 180. While the vehicle propulsion system 100 is operated to propel the vehicle, electrical transmission cable 182 may be disconnected between the power source 180 and the energy storage device 150. The control system 190 may identify and/or control the amount of electrical energy stored at the energy storage device, which may be referred to as the state of charge (SOC).

In other embodiments, the electrical transmission cable 182 may be omitted, where electrical energy may be received wirelessly at the energy storage device 150 from the power source 180. For example, the energy storage device 150 may receive electrical energy from the power source 180 via one or more of electromagnetic induction, radio waves, and electromagnetic resonance. As such, it should be appreciated that any suitable approach may be used for recharging energy storage device 150 from a power source that does not comprise part of the vehicle, such as from solar or wind energy. In this way, the motor 120 may propel the vehicle by utilizing an energy source other than the fuel utilized by the engine 110.

The fuel system 140 may periodically receive fuel from a fuel source residing external to the vehicle. As a non-limiting example, the vehicle propulsion system 100 may be refueled by receiving fuel via a fuel dispensing device 170 as indicated by arrow 172. In some embodiments, fuel tank 144 may be configured to store the fuel received from the fuel dispensing device 170 until it is supplied to the engine 110 for combustion. In some embodiments, control system 190 may receive an indication of the level of fuel stored at the fuel tank 144 via a fuel level sensor. The level of fuel stored at the fuel tank 144 (e.g., as identified by the fuel level sensor) may be communicated to the vehicle operator 102, for example, via a fuel gauge or indication in a vehicle instrument panel 197.

The vehicle propulsion system 100 may also include an ambient temperature/humidity sensor 198, and the like. The vehicle instrument panel 197 may include indicator light(s) and/or a text-based display in which messages are displayed to an operator. The vehicle instrument panel 197 may also include various input portions for receiving an operator input, such as buttons, touch screens, voice input/recognition, etc.

The engine 110 shown in FIG. 1 may be a boosted engine that includes a turbocharger with a compressor and an exhaust drive turbine. Alternatively, the engine 110 may be naturally aspirated.

Referring now to FIG. 2, it shows an example system configuration of an internal combustion engine 200 which may be included in a propulsion system of an automotive vehicle. In one example, engine 200 may be an example of the engine 110 of FIG. 1 in the vehicle propulsion system 100 of FIG. 1.

As shown in FIG. 2, the internal combustion engine 200 may include least one cylinder 202 formed therein via a cylinder head 204 and a cylinder block 206. The cylinder block 206 may include a crankcase 208 that includes an oil reservoir 210 (e.g., oil sump) with oil therein and a crankshaft 212 which is coupled to a piston 214. Cam covers 216 and 220 may be coupled to the cylinder head 204.

A PCV system 218 may further be included in the internal combustion engine 200 and/or vehicle more generally. The PCV system 218 may include an oil separator (e.g., a partial load (pull) oil separator) incorporated in or coupled to the cam cover 216, in one example. The oil separator may be in fluidic communication with the crankcase 208 and is configured to remove oil (e.g., oil droplets) from the gasses flowing therethrough and may return the oil to the oil reservoir 210.

The PCV system 218 further includes a PCV valve 222 which is in fluidic communication with an intake manifold 224 via a PCV conduit 226 (e.g., a PCV tube). In the illustrated example, the PCV valve 222 is coupled to the cam cover 216. However, other PCV valve locations are possible. The PCV valve 222 controls the flowrate of gasses therethrough. The gas flowrate adjustment may be dependent on the intake manifold vacuum. An example of a PCV valve is shown in FIGS. 3-4 and discussed in greater detail herein.

As illustrated in FIG. 2, the intake manifold 224 is included in an intake system 228 which provides gas to the cylinder 202 via an intake valve 272. A throttle 230 may further be included in the intake system 228 which controls the gas flow to the cylinder 202. A compressor 232 (which may be included in a turbocharger or a supercharger) may be included in the intake system 228. However, in other examples, the engine may be configured as a naturally aspirated engine. The intake system 228 may further include an air filter 234 in an intake conduit 236 upstream of the throttle 230 and compressor 232 in the case of a boosted engine.

It will be understood that the PCV system 218 may include additional components such as another oil separator in the cam cover 220, valves in the cam covers that divert oil around the separators, combinations thereof, and the like. Further, an exhaust valve 273 is coupled to the cylinder and allows exhaust gas to flow from the cylinder 202 to an exhaust system. The engine 200 may be configured to implement a four stroke combustion cycle such as the combustion cycle discussed above with regard to FIG. 1.

Engine 200 may be controlled at least partially by a control system such as a control system with a controller (e.g., the control system 190 and the controller 191 shown in FIG. 1)

FIG. 2 illustrates the general flow pattern in the PCV system 218 during a lower load (e.g., partial load)/non-boosted operating condition. Arrows 275 specifically denote the general flow direction of crankcase gasses and arrows 276 indicate the general direction of intake air.

As shown, crankcase gasses flow from the crankcase to the cam, into the PCV conduit 226, and then into the intake manifold 224. Conversely, fresh air flows from the intake conduit 236 to the cam cover 220 via the PCV conduit 240. From the cam cover, fresh air flows into the crankcase 208. Further, oil may flow from the cylinder head 204 to the cylinder block 206 and then to the oil reservoir 210 in the crankcase 208. Thus, oil may travel past the piston ring(s) in the engine.

An axis system is provided in FIG. 2 as well as FIGS. 3-4, for reference. The z-axis may be a vertical axis (e.g., parallel to a gravitational axis), the x-axis may be a longitudinal axis (e.g., horizontal axis), and/or the y-axis may be a lateral axis, in one example. However, the axes may have other orientations, in other examples.

FIGS. 3-4 show an example of a PCV valve 300. It will be understood that the PCV valve 300 serves as an example of the PCV valve 222, that is depicted in FIG. 2. The PCV valve 300 shown in FIGS. 3-4 includes a housing 302 with an orifice plate 304 that is arranged in an interior 306 of the housing. The orifice plate 304 is separately constructed from the housing 302, in the illustrated example. However, the housing and orifice may be constructed as a single component, in other examples. Further, in the illustrated example, the orifice plate 304 is arranged in a recess 308 in an inner surface 310 of the housing 302. In this way, axial movement of the orifice is delimited. Further, the orifice plate 304 includes a central orifice 311 through which crankcase gasses flow during valve operation.

The PCV valve 300 further includes a plunger 312 arranged in the housing 302. Further in the valve, a spring 314 biases the plunger 312. Specifically, the spring 314 is positioned circumferentially outward from the plunger 312. The spring 314 is a helical spring, in the illustrated example. However, other suitable types of springs may be used in the PCV valve, in other examples. The plunger 312 moves up and down along a central axis 344 to open and close the valve.

Further, in the illustrated example, the housing 302 includes multiple flanges 316. To expound, the housing 302 includes an upper flange 318 and a lower flange 320. However, the housing may be constructed with alternate structural characteristics. For instance, one or both of the flanges may be omitted from the housing, in other examples.

A seal 322 may be arranged in a recess 324 in an outer surface 326 of the housing 302. The seal 322 allows the PCV valve 300 to sealing attach to the crankcase for example.

The plunger 312 includes a reduced diameter portion 328, a body 330, and a base 332 in the illustrated example. To elaborate, the reduced diameter portion 328 has a diameter 334 that is less than a diameter 336 of the body 330. Further, the base 332 has a diameter 338 that is greater than the diameter 336 of the body 330. The reduced diameter portion 328 may have a constant diameter along its axial length. Similarly, the body 330 may have a constant diameter along its axial length. A tapered portion 340 of the plunger 312 may be arranged between the reduced diameter portion 328 and the body 330. During valve operation, the plunger 312 moves up and down along the axis 344, as previously indicated. In a closed position, the tapered portion 340 of the plunger seals on the orifice plate 304. Conversely, in an open position, the tapered portion 340 of the plunger moves away from the orifice plate 304 to enable crankcase gas to flow therethrough.

The plunger 312 further includes ribs 342 that interact with the orifice plate 304 to reduce the tilting movement of the plunger 312 off of a central axis 344. To elaborate, during PCV valve operation the plunger 312 moves along the central axis 344 based on crankcase pressure and intake manifold pressure. However, the ribs 342 delimit the plunger 312 with regard to movement into an off-axis position with regard to the central axis 344. Specifically, the ribs 342 may form a slip fit interface 346 with a surface 348 of the orifice plate 304.

The ribs 342 longitudinally extend from an upper end 347 of the plunger 312 to a lower end 357 of the body 330 of the plunger. In this instance, longitudinally refers to a direction that is parallel to the axis 344. In this way, the stability of the plunger 312 is increased as it transitions between open and closed positions, thereby reducing the chance of NVH during valve operation. Each of the ribs 342 may have an inner surface 360 and lateral surfaces 362 that extend from the inner surface to the body 330 and the reduced diameter portion 328. These surfaces may be planar in one example. However, the inner surface 360 may be curved to conform to the curvature of the orifice plate surface 348 and the lateral surfaces 362 may be planar.

The ribs 342 may be equally spaced on the plunger 312 about the central axis 344. To elaborate, the ribs 342 may include one set of ribs 349 with ribs 350 and 351 that are arranged 180º apart about the central axis 344. Further, in the illustrated example, another set of ribs 352 including ribs 353 and 354 is included in the plunger and are arranged 180º apart about the central axis 344. Specifically, the ribs 342 are separated by 90º about the axis 344 in the illustrated example. However, other suitable arrangements of the ribs in the plunger may be used in other examples.

The ribs 342 may be integrally formed in the plunger 312 in one example. However, in other examples. The ribs 342 may be welded, adhesively bonded, and the like to the plunger 312. Further, the ribs 342 and the plunger 312 may be constructed out of suitable materials such as one or more metals, polymers, and the like.

The PCV valve 300 shown in FIGS. 3-4 further includes a lower plate 370 with a central opening 372 to allow crankcase gases to flow therethrough. The lower plate 370 mates with an interior of the housing 302.

FIG. 5 shows another example of a PCV valve 500. The PCV valve 500 again includes a housing 502, a plunger 504, a spring 506, an orifice plate 508, and a lower plate 510. The plunger 504 again includes a base 512, a body 514, and a reduced diameter portion 516. However, the plunger 504 shown in FIG. 5 does not include ribs in the illustrated example. On the other hand, the housing 502 includes ribs 518. To elaborate, the ribs 518 are configured to interact with the reduced diameter portion 516 of the plunger 504 to reduce off-axis movement of the plunger during valve operation, thereby decreasing NVH. Specifically, the ribs 518 include a first set of ribs 520 and 522 and a second set of ribs 524 and 526. To elaborate, in the illustrated example, the ribs 520 and 522 in the first set of ribs are arranged 180º apart with regard to a central axis 550. Similarly, the ribs 524 and 526 in the second set of ribs are arranged 180º apart with regard to a central axis 550, in the illustrated example. However, other rib positions may be used in other examples. Further, in other examples, the housing may include solely one pair or ribs or more than two pairs of ribs.

Upper sides 528 or the ribs 518 are position below an upper opening 530 in the housing 502. Further, the ribs 518 may be positioned above the orifice plate 508 with a gap 532 therebetween. A seal 534 is again positioned in an outer recess of the housing 502.

When the plunger 504 moves upward the reduced diameter portion 516 of the plunger mates with the ribs 520, 522, 524, and 526. In this way, off-axis movement of the plunger 504 is reduced, thereby reducing NVH.

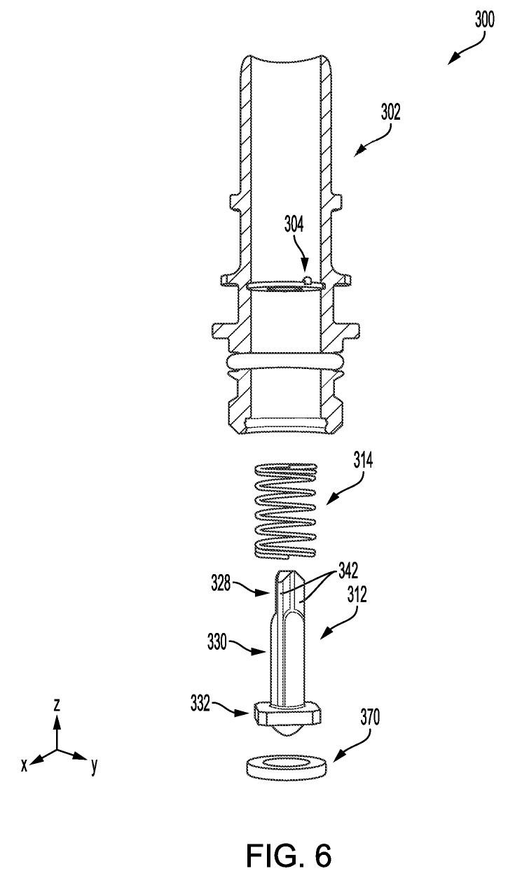

FIG. 6 shows an exploded view of the PCV valve 300. The housing 302, the orifice plate 304, the plunger 312, the spring 314, and the lower plate 370 are again shown. The ribs 342 in the plunger 312 are further shown in FIG. 6. Additionally, the reduced diameter portion 328, the body 330, and the base 332 of the plunger 312 are additionally illustrated in FIG. 6.

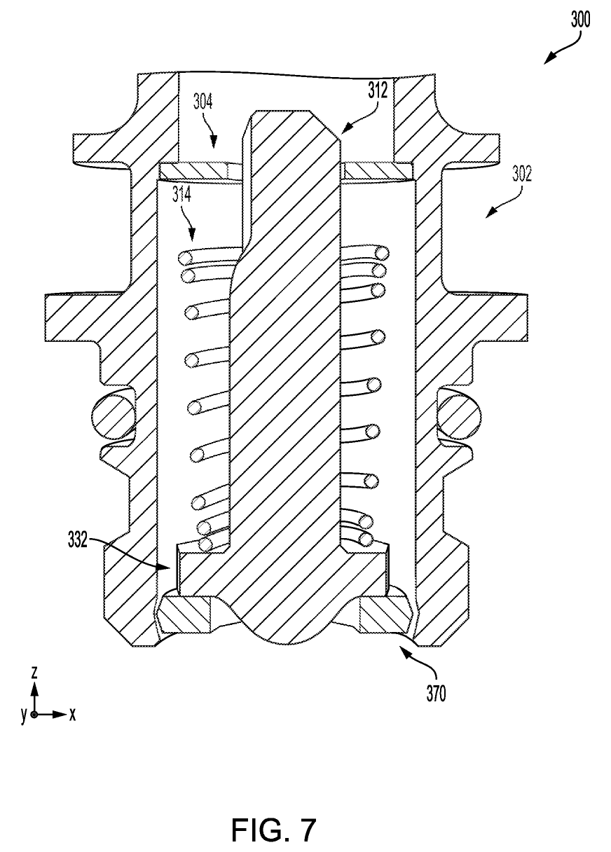

FIG. 7 shows another cross-sectional assembled view of the PCV valve 300. The housing 302, the orifice plate 304, the plunger 312, the spring 314, and the lower plate 370 are again shown. The base 332 of the plunger 312 contacts the lower plate 370, in the illustrated example.

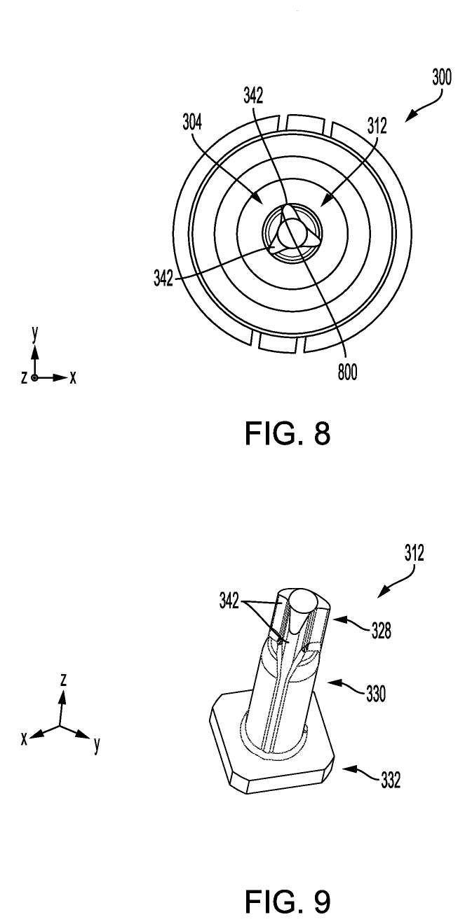

FIG. 8 shows a top view of the PCV valve 300. The ribs 342 of the plunger 312 are shown contacting an inner surface 800 of the orifice plate 304. In this way, off-axis movement of the plunger is inhibited, thereby reducing NVH during valve operation.

FIG. 9 shows a detailed view of the plunger 312. The ribs 342 in the plunger 312 are further shown. Additionally, the reduced diameter portion 328, the body 330, and the base 332 of the plunger 312 are additionally illustrated in FIG. 9.

FIGS. 3-9 are shown approximately to scale. However, the components may have other relative dimensions, in alternate embodiments.

FIGS. 1-9 show example configurations with relative positioning of the various components. Unless otherwise noted, if shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

As one embodiment, a positive crankcase ventilation (PCV) valve is provided that comprises a housing; an orifice plate positioned within the housing; and a plunger biased by a spring and configured to travel axially through the orifice; where multiple longitudinal ribs extend from an outer surface of the plunger along the whole length of the plunger. In one example, the multiple longitudinal ribs may be equivalently spaced about a central axis. Further, in one example, the multiple longitudinal ribs may include a pair of ribs that are arranged 180º apart about the central axis. In yet another example, the multiple longitudinal ribs may include two pairs of ribs each of which are arranged 180º apart about a central axis. In another example, the plunger may include an upper reduced diameter section and a body. In another example, the plunger may include a base positioned below the body. In another example, the PCV valve may further comprise a seal arranged in a recess in the housing. In yet another example, the spring may be a coil spring. In another example, the multiple longitudinal ribs may be integrally formed with the housing.

In another embodiment, a positive crankcase ventilation (PCV) system in an internal combustion engine is provided that comprises a PCV valve including: a housing; an orifice plate positioned within the housing; a spring axially delimited by the orifice; and a plunger biased by the spring and configured to travel axially through the orifice plate; where multiple longitudinal ribs extend from an outer surface of the plunger along the whole length of the plunger. In one example, the multiple longitudinal ribs may include a first pair of ribs. In another example, the first pair of ribs may be arranged 180º apart about a central axis. In another example, the multiple longitudinal ribs may include a second pair of ribs. In another example, the first pair of ribs may be arranged 180º apart about a central axis. In another example, the plunger may include an upper reduced diameter section and a body; and the plunger may include a base positioned below the body. In one example, the internal combustion engine may be a boosted internal combustion engine. In yet another example, the internal combustion engine may be a naturally aspirated internal combustion engine. In another example, the multiple longitudinal ribs may be integrally formed with the housing.

In another representation, a valve in a positive crankcase ventilation (PCV) system is provided that comprises an axially moveable plunger with flutes that form a slip fit interface with an orifice plate.

Note that the example control and estimation routines included herein can be used with various engine and/or vehicle system configurations. The control methods and routines disclosed herein may be stored as executable instructions in non-transitory memory and may be carried out by the control system including the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations, and/or functions may be repeatedly performed depending on the particular strategy being used. Further, the described actions, operations, and/or functions may graphically represent code to be programmed into non-transitory memory of the computer readable storage medium in the engine control system, where the described actions are carried out by executing the instructions in a system including the various engine hardware components in combination with the electronic controller.

It will be appreciated that the configurations and routines disclosed herein are exemplary in nature, and that these specific embodiments are not to be considered in a limiting sense, because numerous variations are possible. For example, the above technology can be applied to V-6, I-4, I-6, V-12, opposed 4, and other engine types. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A positive crankcase ventilation (PCV) valve, comprising:
a housing;
an orifice plate positioned within the housing; and
a plunger biased by a spring and configured to travel axially through the orifice plate;
where the housing or the plunger includes multiple longitudinal ribs extend along an outer surface of the plunger or an inner surface of the housing to the orifice plate.

2. The PCV valve of claim 1, where the multiple longitudinal ribs are equivalently spaced about a central axis.

3. The PCV valve of claim 2, where the multiple longitudinal ribs include a pair of ribs that are arranged 180º apart about the central axis.

4. The PCV valve of claim 1, where the multiple longitudinal ribs include two pairs of ribs each of which are arranged 180º apart about a central axis.

5. The PCV valve of claim 1, where the plunger includes an upper reduced diameter section and a body.

6. The PCV valve of claim 5, where the plunger includes a base positioned below the body.

7. The PCV valve of claim 1, further comprising a seal arranged in a recess in the housing.

8. The PCV valve of claim 1, where the spring is a coil spring.

9. The PCV valve of claim 1, where the multiple longitudinal ribs form a slip fit interface with the orifice plate.

10. The PCV valve of claim 1, where the multiple longitudinal ribs are integrally formed with the housing.

11. A positive crankcase ventilation (PCV) system in an internal combustion engine, comprising:
a PCV valve including:
a housing;
an orifice plate positioned within the housing;
a spring axially delimited by the orifice plate; and
a plunger biased by the spring and configured to travel axially through the orifice plate;
where multiple longitudinal ribs extend along:
an outer surface of the plunger along the whole length of the plunger; or
along an inner surface of the housing to the orifice plate and are configured to delimit.

12. The PCV system of claim 11, where the multiple longitudinal ribs include a first pair of ribs.

13. The PCV system of claim 12, where the first pair of ribs are arranged 180º apart about a central axis.

14. The PCV system of claim 13, where the multiple longitudinal ribs include a second pair of ribs.

15. The PCV system of claim 14, where the first pair of ribs are arranged 180º apart about a central axis.

16. The PCV system of claim 11, where:
the plunger includes an upper reduced diameter section and a body; and
the plunger includes a base positioned below the body.

17. The PCV system of claim 11, where the internal combustion engine is a boosted internal combustion engine.

18. The PCV system of claim 11, where the internal combustion engine is a naturally aspirated internal combustion engine.

19. The PCV system of claim 11, where the multiple longitudinal ribs form a slip fit interface with the orifice plate.

20. The PCV system of claim 19, where the multiple longitudinal ribs are integrally formed with the housing.
